(19) United States
(12) Patent Application Publication
(10) Pub. No.: US 2013/0087499 A1
(43) Pub. Date: Apr. 11, 2013

(54) SPIRAL SEPARATION MEMBRANE ELEMENT, PERFORATED HOLLOW TUBE, AND METHOD OF PRODUCING THE SAME

(71) Applicants: Yasuhiro Uda, Osaka (JP); Toshimitsu Hamada, Osaka (JP); Shinichi Chikura, Osaka (JP)

(72) Inventors: Yasuhiro Uda, Osaka (JP); Toshimitsu Hamada, Osaka (JP); Shinichi Chikura, Osaka (JP)

(73) Assignee: NITTO DENKO CORPORATION, Ibaraki-shi, Osaka (JP)

(21) Appl. No.: 13/704,476

(22) PCT Filed: Jun. 17, 2011
(86) PCT No.: PCT/JP2011/003485

§ 371 Date: Dec. 14, 2012

(30) Foreign Application Priority Data
Jun. 18, 2010 (JP) 2010-139975

(51) Int. Cl. B01D 63/10; F16L 9/00

(52) U.S. Cl. CPC B01D 63/10; F16L 9/00
USPC 210/497.1; 138/177; 264/328.1

(57) ABSTRACT

The spiral separation membrane element of the present invention includes: a perforated hollow tube (1) having a plurality of perforations (2) leading from an outer peripheral surface to an inner peripheral surface thereof; and a stack that includes a separation membrane and a passage member and that is wound around the perforated hollow tube (1). A bottomed recessed portion (3) is provided in a region covered by the stack on the outer peripheral surface of the perforated hollow tube (1). According to the present invention, permeated liquid flows into the bottomed recessed portion (3). Since the permeated liquid can flow smoothly in the bottomed recessed portion (3), the resistance to the permeated liquid can be reduced. As a result, the pressure loss can be reduced and the amount of the permeated liquid can be increased.

### TECHNICAL FIELD

The present invention relates to a spiral separation membrane element. The present invention also relates to a perforated hollow tube that can be used in the spiral separation membrane element and a method of producing this perforated hollow tube.

### BACKGROUND ART

A perforated hollow tube having a plurality of perforations leading from the outer peripheral surface to the inner peripheral surface thereof can be used, for example, as a central tube for a spiral separation membrane element used for wastewater purification and seawater desalination. In this spiral separation membrane element, a reverse osmosis membrane, a microfiltration membrane or an ultrafiltration membrane is used as a separation membrane, and such membrane elements have been practically used. In recent years, with an increasing demand for such spiral separation membrane elements, the need for significant improvements in their separation performance has also increased. Therefore, not only improvements in the performance of a separation membrane but also improvements in the performance of a separation membrane element as a whole, such as a reduction in pressure loss in the element, have been studied. Conventionally, for this central tube, the percentage of perforation opening area (see, for example, Patent Literature 1) and the structure of the inner peripheral surface of the central tube (see, for example, Patent Literature 2), etc. have been studied, but further improvements in the performance are still needed.

### CITATION LIST

### Patent Literature

Patent Literature 1 JP 2004-305823 A

Patent Literature 2 JP 2007-111674 A

### SUMMARY OF INVENTION

### Technical Problem

It is an object of the present invention to provide a spiral separation membrane element capable of reducing the pressure loss and increasing the amount of permeated liquid. It is another object of the present invention to provide a perforated hollow tube that can be used in the spiral separation membrane element and a method of producing the same.

### Solution to Problem

The present invention provides a spiral separation membrane element including: a perforated hollow tube having a plurality of perforations leading from an outer peripheral surface to an inner peripheral surface thereof and a stack that includes a separation membrane and a passage member and that is wound around the perforated hollow tube. In this element, a bottomed recessed portion is provided in a region covered by the stack on the outer peripheral surface of the perforated hollow tube.

The present invention also provides a perforated hollow tube having a plurality of perforations leading from an outer peripheral surface to an inner peripheral surface thereof. In this tube, a bottomed recessed portion is provided on the outer peripheral surface, and the plurality of perforations open into the bottom of this bottomed recessed portion.

The present invention further provides a method of producing the perforated hollow tube by injection molding. In this method, a resin is injected into a mold and cured. The mold includes: a core mold for forming an interior space of the perforated hollow tube; and a main mold containing the core mold and having a projected portion for forming the bottomed recessed portion and bosses for forming the plurality of perforations.

### Advantageous Effects of Invention

According to the present invention, permeated liquid flows into the bottomed recessed portion. Since the permeated liquid can flow smoothly in the bottomed recessed portion, the resistance to the permeated liquid can be reduced. As a result, the pressure loss can be reduced and the amount of the permeated liquid can be increased.

### BRIEF DESCRIPTION OF DRAWINGS

FIG. 1 is a perspective view showing a perforated hollow tube used in a spiral separation membrane element according to an embodiment of the present invention.

FIG. 2 is an exploded perspective view showing a configuration example of the spiral separation membrane element.

FIG. 3A is a perspective view of a stack which has not yet been wound around the perforated hollow tube, and FIG. 3B is a schematic sectional view of the stack which has been wound around the perforated hollow tube.

FIG. 4A is a sectional view of a mold used for producing the perforated hollow tube shown in FIG. 1, and FIG. 4B is a sectional view showing an example in which the perforated hollow tube is divided into a plurality of pieces in the axial direction.

FIG. 5 is a perspective view showing a perforated hollow tube of a first modification.

FIG. 6A is a side view showing a perforated hollow tube of a second modification, and FIG. 6B is a sectional view of this perforated hollow tube.

FIG. 7A is a side view showing a perforated hollow tube of a third modification, and FIG. 7B is a sectional view of this perforated hollow tube.

FIG. 8A to 8C are side views showing perforated hollow tubes of fourth to sixth modifications, respectively.

FIG. 9A is a side view showing a perforated hollow tube of a seventh modification, and FIG. 9B is a sectional view of this perforated hollow tube.

FIG. 10A is a side view showing a perforated hollow tube of a eighth modification, and FIG. 10B is a sectional view of this perforated hollow tube.

### DESCRIPTION OF EMBODIMENTS

Hereinafter, embodiments of the present invention will be described with reference to the drawings. The following description relates to exemplary embodiments of the present invention, and the present invention is not limited by these.

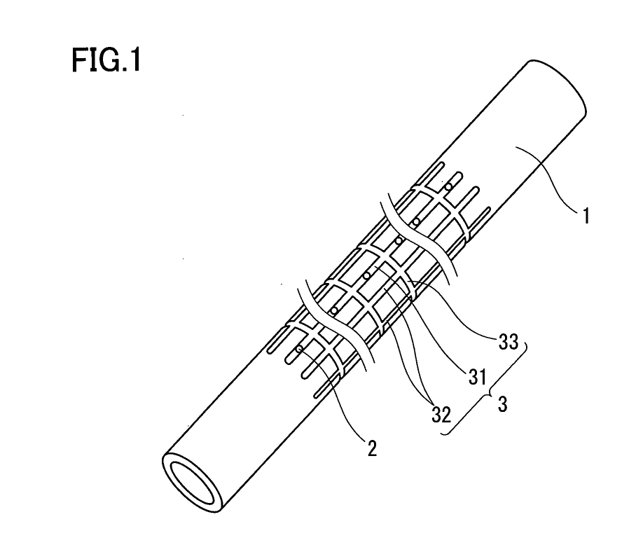

FIG. 1 shows a perforated hollow tube 1 used in a spiral separation membrane element according to an embodiment of the present invention. This perforated hollow tube 1 has a plurality of perforations 2 leading from the outer peripheral surface to the inner peripheral surface thereof. The material for the perforated hollow tube 1 is not particularly limited, but the perforated hollow tube 1 is preferably an inflexible rigid body. For example, a metal, resin or ceramic tube is preferably used.

As a metal, for example, iron, aluminum, stainless steel, copper, brass, bronze, duralumin, or an alloy containing two or more metal elements can be used. For the purpose of water purification, stainless steel is preferably used in terms of cost, strength and corrosion resistance.

As the resin, a thermosetting resin or a thermoplastic resin can be used. Examples of thermosetting resins include epoxy resins, phenol resins, melamine resins, urea resins, alkyd resins, unsaturated polyester resins, polyurethanes, thermosetting polyimides, silicone resins, and diaryl phthalate resins. Among them, epoxy resins, melamine resins, and silicone resins are preferably used. Examples of thermoplastic resins include polyethylene resins, polystyrene resins, polypropylene resins, polycarbonate resins, polyacetal resins, polyamide-based resins, polysulfone resins, polyester-based resins (such as polyethylene terephthalate resins and polybutylene terephthalate resins), modified polyphenylene oxide resins (such as modified polyphenylene ether resins), polyphenylene sulfide resins, acrylonitrile-butadiene-styrene copolymer resins, acrylonitrile-styrene copolymer resins, polymethyl methacrylate resins, and mixtures and polymer alloys thereof.

In order increase the strength of the resin, a fibrous material such as glass fibers or carbon fibers, or a crystalline material such as whiskers or a liquid crystal polymer may be added to the resin composition. Examples of glass fibers include glass wool, chopped glass fibers, and milled glass fibers. Example of carbon fibers include milled carbon fibers. Examples of whiskers include aluminum borate whiskers, potassium titanate whiskers, basic magnesium sulfate whiskers, calcium silicate whiskers, and calcium sulfate whiskers.

Various additives may further be added to improve the properties of the resin. For example, a flame retardant, a stabilizer, a pigment, a dye, a mold release agent, a lubricant, a weather resistance improving agent, etc. may be added to the resin composition. These additives may be used alone, but can be used as a mixture of two or more of them.

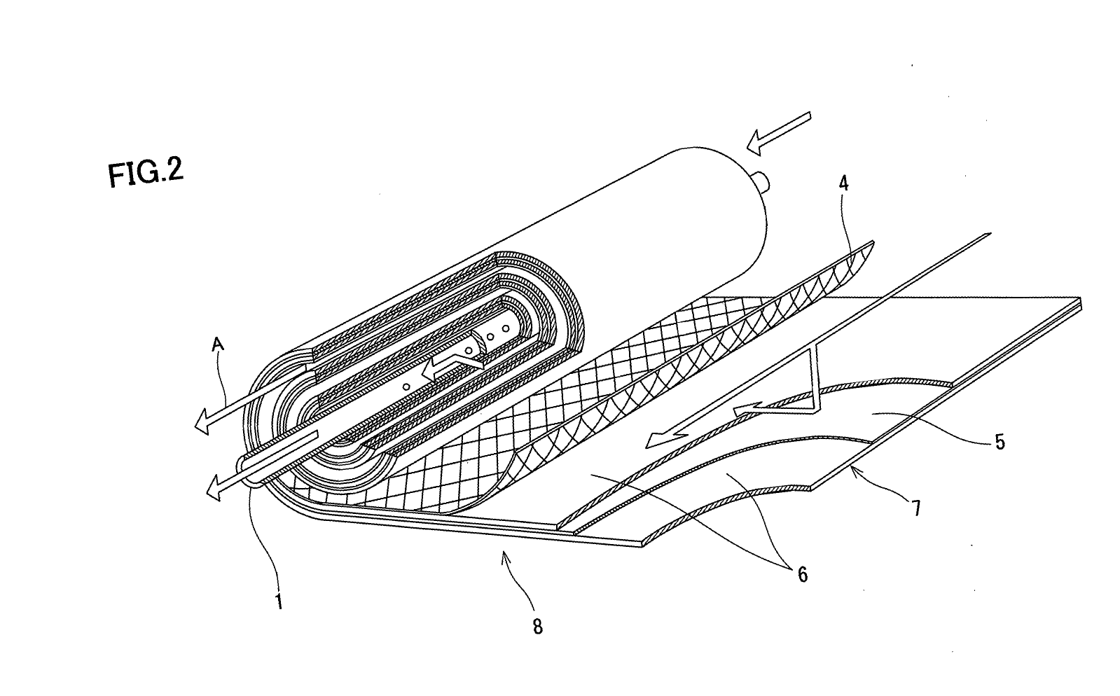

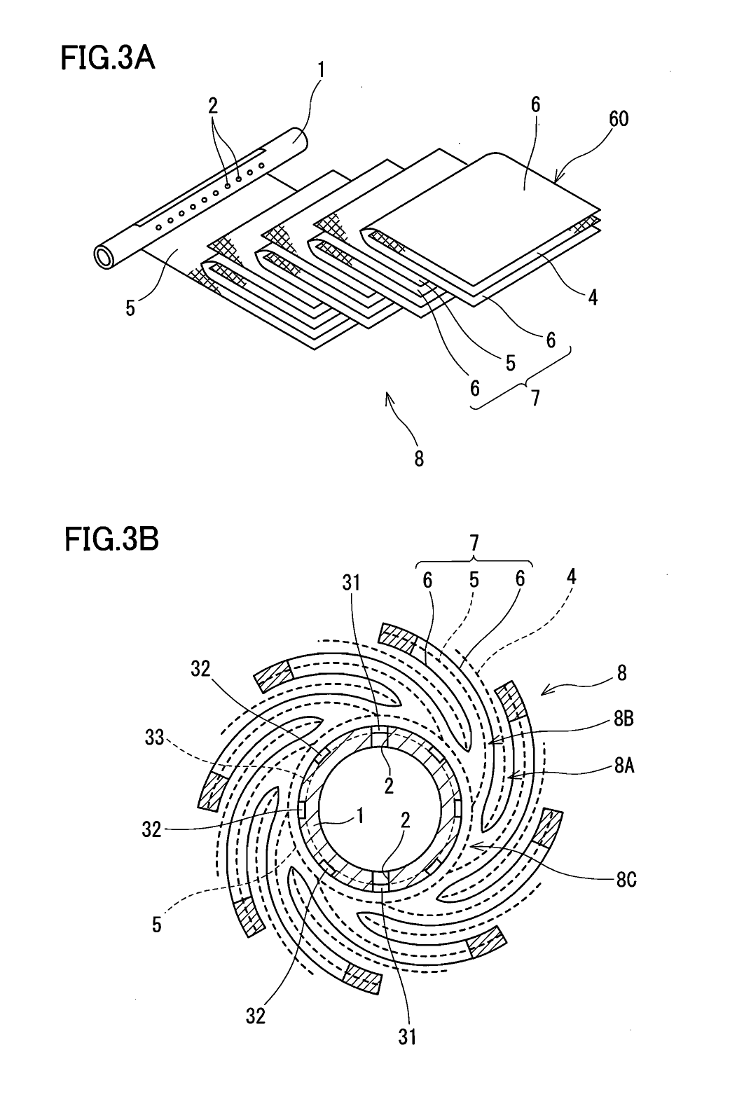

The number and size of the perforations 2 provided in the perforated hollow tube 1 may be determined as appropriate. For example, in the case where the perforated hollow tube 1 has an outer diameter of 30 to 40 mm in a spiral separation membrane element with a diameter of about 8 inches, the diameter of the perforations 2 is about 2 to 8 mm, and further, the number of the perforations 2 is preferably about 50 to 200. Preferably, the perforations 2 are aligned in at least one line extending in the axial direction of the perforated hollow tube 2. In the present embodiment, as shown in FIG. 2 and FIG. 3B, the perforations 2 are arranged in two lines so that they are located at 180-degree opposite positions with respect to the central axis of the perforated hollow tube 2.

Furthermore, a bottomed recessed portion 3 is provided on the outer peripheral surface of the perforated hollow tube 1 so that the perforations 2 open into the bottom of the bottomed recessed portion 3. This bottomed recessed portion 3 is believed to have an effect of reducing pressure loss in the element because it is effective in introducing the permeated liquid into the perforations 2 smoothly. As used herein, the bottomed recessed portion 3 refers to a thinned portion of the perforated hollow tube 1.

In the present embodiment, the bottomed recessed portion 3, which is composed of communicating grooves 31, parallel grooves 32 and connecting grooves 33, ensures the flow passage of the permeated liquid. The depths and widths of these grooves 31 to 33 are not particularly limited. For example, in the case where the perforated hollow tube 1 has an outer diameter of 30 to 40 mm in a spiral separation membrane element with a diameter of about 8 inches, the depths of the grooves 31 to 33 are, for example, about 0.5 mm to 2 mm, and the widths thereof are, for example, about 1 mm to 3 mm.

The communicating grooves 31 communicate the perforations 2 aligned in the lines on a line-by-line basis. Preferably, the communicating grooves 31 extend in the axial direction of the perforated hollow tube 1 so that they are parallel to the flow direction of a fluid in the spiral separation membrane element. Since this structure allows the permeated liquid to be linearly guided along the communicating grooves 31, the effect of reducing the pressure loss in the element can further be enhanced. Each of the communicating grooves 31 may be provided continuously, but may intentionally be provided discontinuously.

The parallel grooves 32 are parallel to the communicating grooves 31, and these grooves 31 and 32 together divide the outer peripheral surface of the perforated hollow tube 1 in the circumferential direction thereof. For example, the communicating grooves 31 and the parallel grooves 32 are arranged at regular angular intervals. The connecting grooves 33 connect the communicating grooves 31 and the parallel grooves 32. The connection of the parallel grooves 32 to the communicating grooves 31 as in the present embodiment allows not only the permeated liquid to flow smoothly in the bottomed recessed portion 3 but also the risk of pressure loss to be reduced when the permeated liquid passes through a passage member. Therefore, the pressure loss in the element can be reduced compared with an element without the connecting grooves 33. The number and extending direction of the connecting grooves 33 are not particularly limited, and they may be determined as appropriate depending on the flow direction of the permeated liquid. For example, as shown in FIG. 1, the connecting grooves 33 extending in the circumferential direction may be arranged so as to pass through the midpoint of the adjacent perforations 2.

The cross-sectional shapes of the grooves 31 to 33 are not particularly limited and can be designed as appropriate. For example, they may be rectangular, U-shaped, V-shaped or semicircular, or have stepped side walls. In the case where the groove is rectangular or V-shaped in cross section, the bottom edge of the groove is preferably rounded with a radius of 0.5 mm or more and 2 mm or less. This allows not only the flow resistance to be further reduced but also the stress concentration on the edge to be relieved under pressurized conditions. Therefore, the deterioration or damage of the grooves can be prevented.

Preferably, in the axial direction of the perforated hollow tube 1, a region where the bottomed recessed portion 3 is provided does not reach either end of the perforated hollow tube 1 so that the bottomed recessed portion 3 is provided in a region covered by a stack 8 to be described later (see FIG. 3A) on the outer peripheral surface of the perforated hollow tube 1. A separation membrane commonly used in the spiral separation membrane element is folded into two and sealed along three edges thereof. A part of this sealed portion is bonded to the end of the perforated hollow tube 1. If the bottomed recessed portion 3 overlaps this bonded portion, the permeated liquid may leak therefrom and the separation efficiency may decrease. Therefore, a structure in which the bottomed recessed portion 3 is not formed in the region where the sealed portion of the separation membrane is in contact with the perforated hollow tube 1 can be used particularly preferably.

As shown in FIG. 2, the perforated hollow tube 1 and a stack 8 which is spirally wound around the perforated hollow tube 1 constitute a spiral separation membrane element. As shown in FIGS. 3A and 3B, the stack 8 has a configuration in which feed-side passage members 4 made of a synthetic resin net and envelope-like (bag-like) membrane leaves 7, each of which is formed by stacking separation membranes 6 on both sides of a permeate-side passage member 5 made of a synthetic resin net and bonding them along three edges of the leaf, are alternately stacked. The permeate-side passage member 5 forms a permeate-side flow passage 8B for allowing the permeated liquid to flow between the separation membranes 6, and the feed-side passage member 4 forms a feed-side flow passage 8A for allowing the feed liquid to flow between the membrane leaves 7. The opening of the membrane leaf 7 is attached to the perforated hollow tube 1.

For example, two separation membranes 6 are formed by folding a single continuous sheet 60 into two with the feed-side passage member 4 sandwiched therebetween. The separation membranes 7 thus formed are joined together along three edges thereof with the permeate-side passage member 5 sandwiched therebetween. Thus, the membrane leaf 7 is obtained. An adhesive is used for this joining. For example, one of the permeate-side passage members 5 is elongated, the elongated portion is directly wound around the perforated hollow tube 1, and both ends of the elongated portion are sealed with an adhesive to form a tubular flow passage 8C along the outer peripheral surface of the perforated hollow tube 1. The openings of the membrane leaves 7 communicate with the perforations 2 through this tubular flow passage 8C. The configuration of the stack 8 is not limited to that shown in FIGS. 3A and 3B. For example, all the separation membranes 6 may be connected in the form of an accordion folded continuous sheet.

The separation membrane 6 has a structure in which, for example, a porous support and a skin layer (separation functional layer) are stacked in this order on a nonwoven fabric layer. The component material of the nonwoven fabric layer is not particularly limited, and a conventionally known material can be used.

For the component material of the porous support, a conventionally known one can be used. Examples of the material include polyarylether sulfone such as polysulfone or polyether sulfone, polyimide, polyvinylidene fluoride, and epoxy.

The skin layer is not permeable to a substance to be separated in the feed liquid and has a function of separating the substance. The component material of the skin layer is not particularly limited, and a conventionally known material can be used. Specific examples of the material include polyethylene (PE), polypropylene (PP), polyethylene terephthalate (PET), nylon, polyamide, polyacrylonitrile (PAN), polyvinyl alcohol (PVA), PMMA, polysulfone, polyether sulfone, polyimide, and ethylene-vinyl alcohol copolymer.

For the feed-side passage member 4, a conventionally known material such as a net material, a mesh material, a grooved sheet, or a corrugated sheet can be used. For the permeate-side passage member 5, a conventionally known material such as a net material, a knitted material, a mesh material, a grooved sheet, or a corrugated sheet can be used.

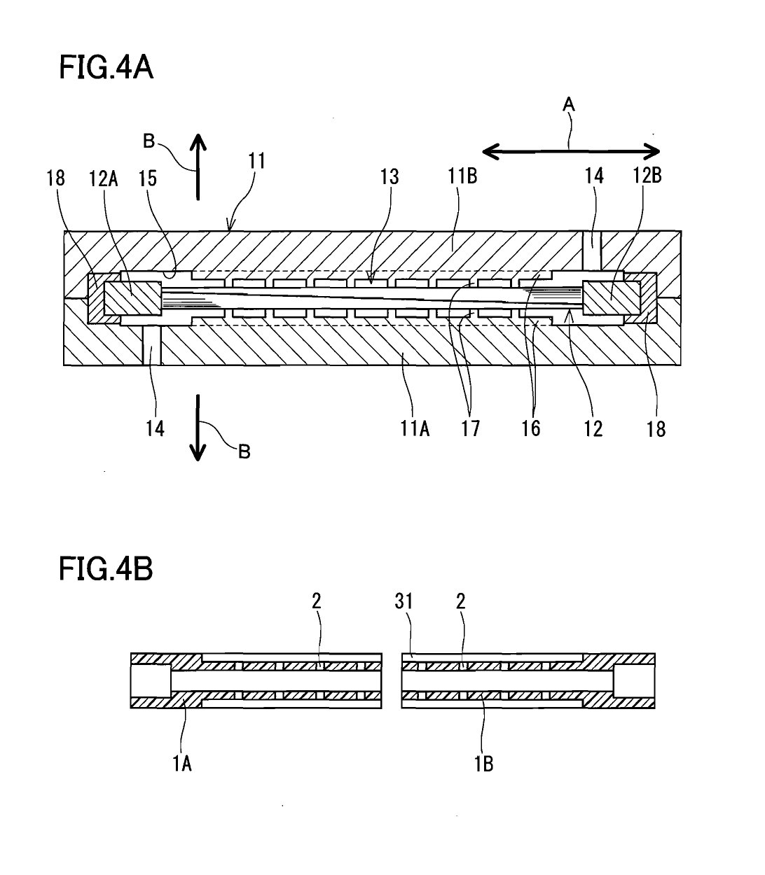

The method of producing the perforated hollow tube 1 is not particularly limited, and a conventionally known method can be used. Examples of the method include a method of perforating and cutting/grooving a hollow resin tube or a hollow metal tube obtained by extrusion molding and a method of cutting/grooving a perforated hollow resin or ceramic tube obtained by a molding technique using a mold or the like, such as injection molding. Among these methods, the present inventors have found a method of producing the perforated hollow tube 1 efficiently and with high productivity. The method is a method of producing the perforated hollow tube 1 by injection molding in which a resin is injected into a mold and cured. FIG. 4A shows an example of this mold.

The mold shown in FIG. 4A includes a core mold 12, a main mold 11 containing the core mold 12, and an auxiliary member 18 for fixing the core mold 12 to the main mold 11. Molding chambers 13 are formed between the core mold 12 and the main mold 11. The core mold 12 forms an interior space of the perforated hollow tube 1. The main mold 11 has a projected portion 16 for forming the bottomed recessed portion 3 and bosses 17 for forming the perforations 2.

The main mold 11 is composed of a pair of main parts 11A and 11B, which are clamped in contact with each other but are separable from each other in the direction perpendicular to the axial direction of the perforated hollow tube 1. Each of the parts 11A and 11B is provided with a resin pouring gate 14. The core mold 12 is composed of a pair of core parts 12A and 12B, which are fixed to the main mold 11 in contact with each other but are separable in the axial direction of the perforated hollow tube 1.

The perforated hollow tube 1 does not necessarily have to be injection-molded in its entirety. For example, as shown in FIG. 4B, the perforated hollow tube 1 can also be produced from a plurality of (two as shown in the example shown in this figure, or three or more) pieces 1A and 1B separable in the axial direction, by injection-molding the pieces 1A and 1B separately using a mold as shown in FIG. 4A and then joining them together. In this case, the joining method is not particularly limited, and a known technique such as resin bonding, heat welding, ultrasonic welding, and rotational friction welding can be used as appropriate.

(Modifications)

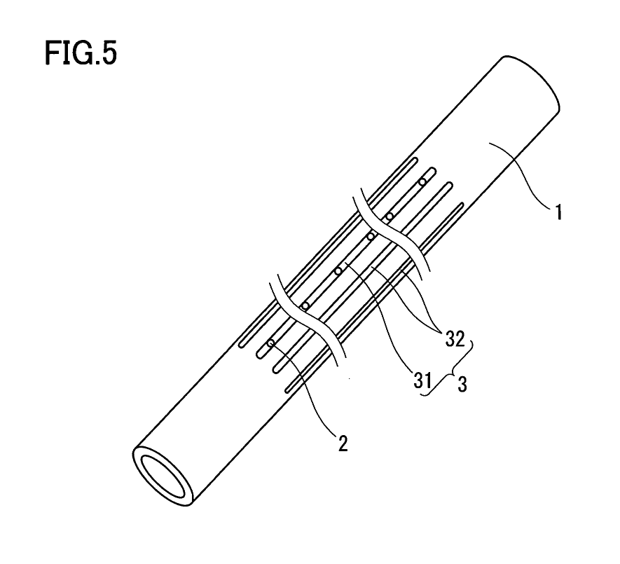

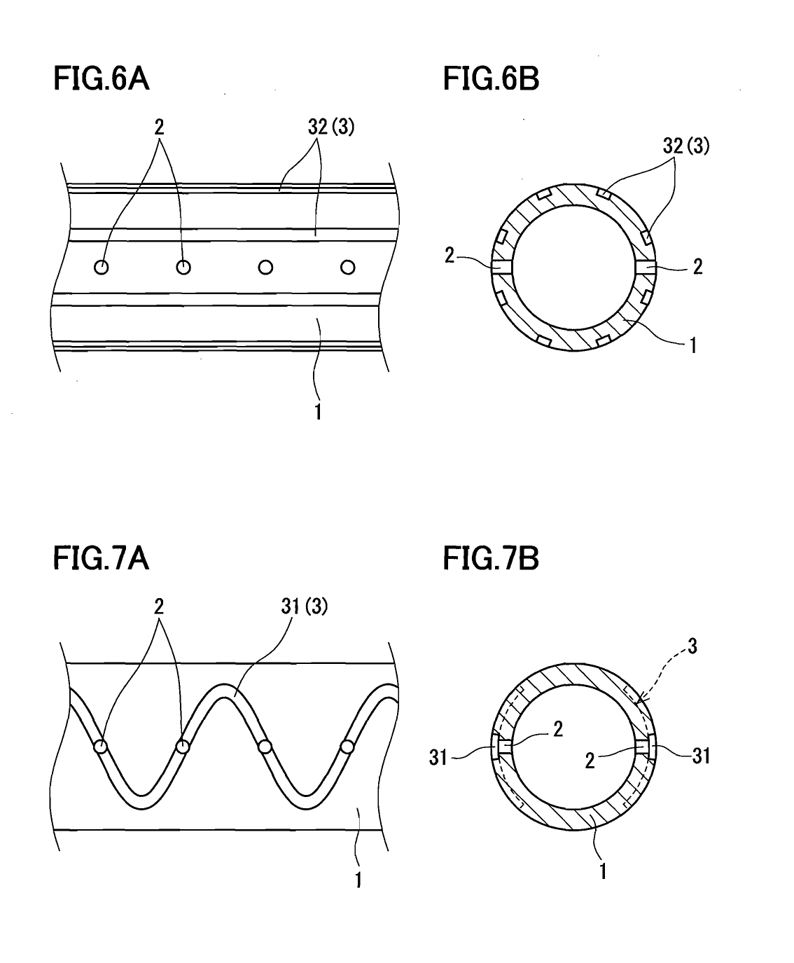

The configuration of the bottomed recessed portion 3 is not limited to that as described above, and can be modified in various ways. For example, as shown in FIG. 5, the bottomed recessed portion 3 may consist only of the communicating grooves 31 and the parallel grooves 32. As shown in FIGS. 6A and 6B, the bottomed recessed portion 3 may consist only of the parallel grooves 32 arranged at regular angular intervals, without the communicating grooves 31. That is, the plurality of perforations 2 do not have to open into the bottom of the bottomed recessed portion 3. This configuration allows the permeated liquid to flow into any of the parallel grooves 32 and then take the shortest route to the perforations 2 through the permeate-side passage member 5 along the outer peripheral surface of the perforated hollow tube 1, resulting in some reduction in the flow resistance of the permeated liquid. However, in the case where the perforations 2 open into the bottom of the bottomed recessed portion 3, the bottomed recessed portion 3 serves as a flow passage for introducing the permeated liquid into the perforations 2, resulting in a significant reduction in the flow resistance of the permeated liquid.

Furthermore, the communicating groove 31 does not necessarily have to extend in the axial direction of the perforated hollow tube 1. As shown in FIG. 7A and FIG. 7B, the communicating groove 31 may meander in a wave-like pattern with a wavelength twice the pitch of the perforations 2. Although not shown in the figures, the communicating groove 31 may be formed spirally so that it passes over the perforations 2 one by one per spiral turn.

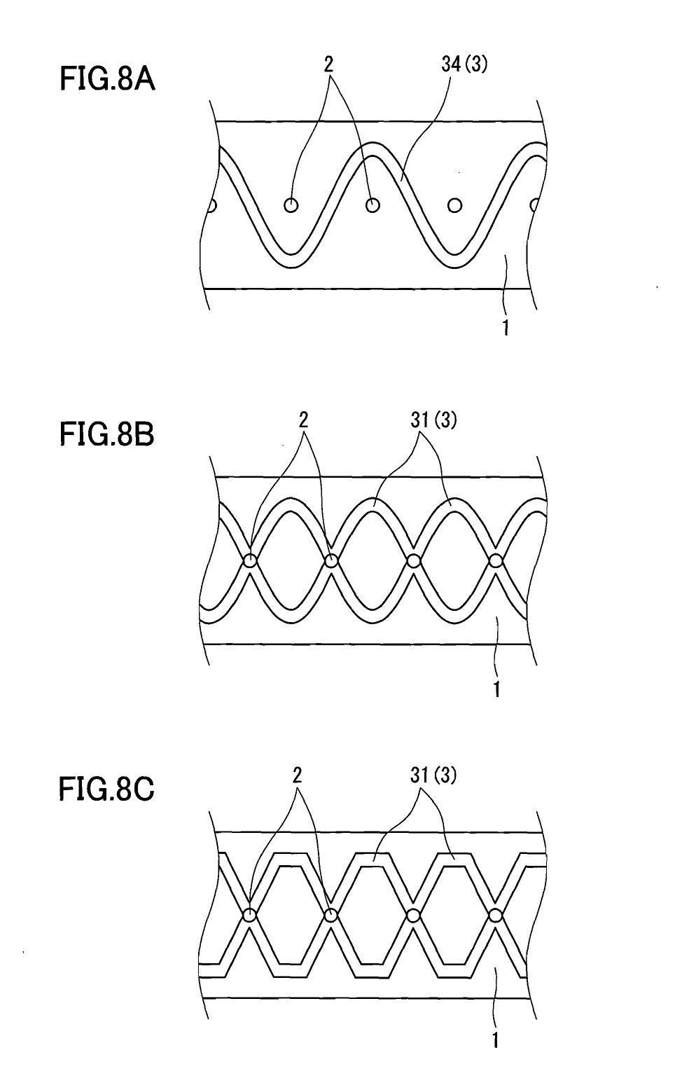

Furthermore, as shown in FIG. 8A, the bottomed recessed portion 3 may consist only of a meandering groove 34 which is shifted from the communicating groove 31 shown in FIG. 7A in the axial direction of the perforated hollow tube 1 by a half of the pitch of the perforations 2. As shown in FIG. 8B, the communicating grooves 31 meandering in a wave-like pattern with a wavelength twice the pitch of the perforations 2 may be provided symmetrically with respect to the line of the perforations 2 so that they intersect each other on the perforations 2. Furthermore, the waves of the communicating groove 31 do not have to have a smoothly curved shape, and they may be angular waves as shown in FIG. 8C.

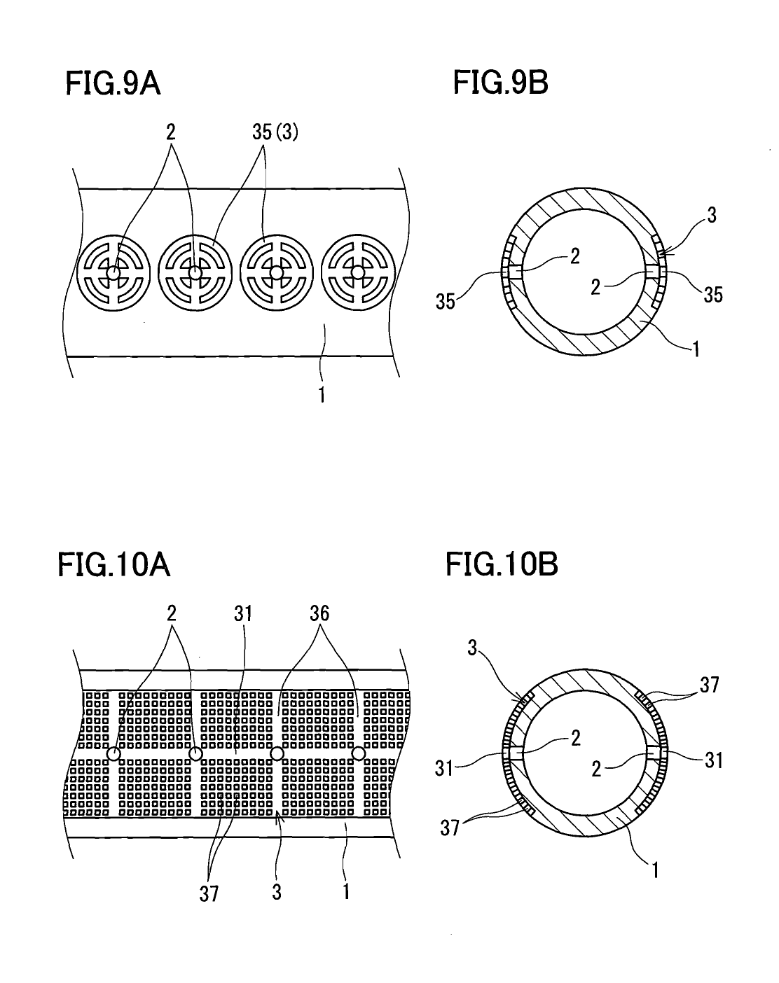

Or the bottomed recessed portion 3 may be composed of individual dents 35 provided in one-to-one correspondence with the perforations 2, as shown in FIGS. 9A and 9B. In the example shown in this figure, each of the individual dents 35 is composed of a cross-shaped groove and concentric grooves. The bottom of the individual dent 35 may be a curved surface parallel to the outer peripheral surface of the perforated hollow tube 1, or a flat surface perpendicular to the axial direction of the perforation 2.

Furthermore, the bottomed recessed portion 3 may have a configuration as shown in FIGS. 10A and 10B. In this configuration, in addition to the communicating groove 31 extending in the axial direction of the perforated hollow tube 1, circumferential grooves 36 each extending in two opposite directions from each of the perforations 21 are provided on the outer peripheral surface of the perforated hollow tube 1. Moreover, in each of the regions partitioned by the communicating groove 31 and the circumferential grooves 32, a grid of small grooves is provided to form a matrix of dots 37. The dots 37 do not necessarily have to be rectangular in shape, and they may have another shape such as a circular shape. The bottomed recessed portion 3 may consist only of the grids of grooves, without the communicating groove 31 and the circumferential groove 32.

### DESCRIPTION OF REFERENCE NUMERALS

1: Perforated hollow tube
2: Perforation
3: Bottomed recessed portion
31: Communicating groove
32: Parallel groove
33: Connecting groove
36: Individual dent
4: Feed-side passage member
5: Permeate-side passage member
6: Separation membrane
7: Membrane leaf
8: Stack
11: Main mold
12: Core mold
13: Molding chamber
14: Resin pouring gate
16: Projected portion
17: Boss
18: Auxiliary core mold fixing member
A: Fluid flow direction
B: Main mold removal direction

1. A spiral separation membrane element comprising:
a perforated hollow tube having a plurality of perforations leading from an outer peripheral surface to an inner peripheral surface thereof; and
a stack that includes a separation membrane and a passage member and that is wound around the perforated hollow tube,
wherein a bottomed recessed portion is provided in a region covered by the stack on the outer peripheral surface of the perforated hollow tube.

2. The spiral separation membrane element according to claim 1, wherein the plurality of perforations open into the bottom of the bottomed recessed portion.

3. The spiral separation membrane element according to claim 2, wherein
the plurality of perforations are aligned in at least one line extending in an axial direction of the perforated hollow tube, and
the bottomed recessed portion includes a communicating groove for communicating the perforations aligned in the line on a line-by-line basis.

4. The spiral separation membrane element according to claim 3, wherein the communicating groove extends in the axial direction of the perforated hollow tube.

5. The spiral separation membrane element according to claim 4, wherein the bottomed recessed portion includes a plurality of parallel grooves, and the parallel grooves and the communicating groove together divide the outer peripheral surface in a circumferential direction thereof.

6. The spiral separation membrane element according to claim 5, wherein the bottomed recessed portion includes a connecting groove for connecting the communicating groove and the plurality of parallel grooves.

7. The spiral separation membrane element according to claim 2, wherein the bottomed recessed portion is composed of individual dents provided in one-to-one correspondence with the plurality of perforations.

8. A perforated hollow tube having a plurality of perforations leading from an outer peripheral surface to an inner peripheral surface thereof, wherein a bottomed recessed portion is provided on the outer peripheral surface, and the plurality of perforations open into the bottom of the bottomed recessed portion.

9. The perforated hollow tube according to claim 8, wherein
the plurality of perforations are aligned in at least one line extending in an axial direction of the perforated hollow tube, and
the bottomed recessed portion includes a communicating groove for communicating the perforations aligned in the line on a line-by-line basis.

10. The perforated hollow tube according to claim 9, wherein the communicating groove extends in the axial direction of the perforated hollow tube.

11. The perforated hollow tube according to claim 10, wherein the bottomed recessed portion includes a plurality of parallel grooves, and the parallel grooves and the communicating groove together divide the outer peripheral surface in a circumferential direction thereof.

12. The perforated hollow tube according to claim 11, wherein the bottomed recessed portion includes a connecting groove for connecting the communicating groove and the plurality of parallel grooves.

13. The perforated hollow tube according to claim 9, wherein a bottom edge of the communicating groove is rounded with a radius of 0.5 mm or more and 2 mm or less.

14. The perforated hollow tube according to claim 8, wherein in the axial direction of the perforated hollow tube, a region where the bottomed recessed portion is provided does not reach either end of the perforated hollow tube.

15. A method of producing the perforated hollow tube according to claim 8 by injection molding, wherein
a resin is injected into a mold and cured, the mold including: a core mold for forming an interior space of the perforated hollow tube; and a main mold containing the core mold and having a projected portion for forming the bottomed recessed portion and bosses for forming the plurality of perforations.
